(19) United States
(12) Patent Application Publication
(10) Pub. No.: US 2026/0148197 A1
(43) Pub. Date: May 28, 2026

(54) MACHINE LEARNING SYSTEMS AND METHODS FOR GENERATING CALENDAR EVENT DATA FROM ONE OR MORE INPUT DATA TYPES

(71) Applicant: State Farm Mutual Automobile Insurance Company, Bloomington, IL (US)

(72) Inventor: Olivia Nauman, Phoenix, AZ (US)

(21) Appl. No.: 19/359,234

(22) Filed: Oct. 15, 2025

Related U.S. Application Data
(60) Provisional application No. 63/723,930, filed on Nov. 22, 2024.

(51) Int. Cl. G06Q 10/1093

(52) U.S. Cl. CPC G06Q 10/1093

(57) ABSTRACT

A computer system may be configured or programmed to: (1) receive input data from a user device of the one or more user computing devices, wherein the input data includes one or more data types; (2) input the input data into a machine learning model to identify at least some event data included within the input data, the event data associated with defining an event; (3) cause the machine learning model to extract the event data from the input data; (4) using the machine learning model, determine that the event data includes event parameters that only partially define the event; (5) using the machine learning model, identify additional event data that includes additional event parameters needed to completely define the event; and/or (6) cause the machine learning model to retrieve at least one of the additional event parameters by searching additional data sources for the additional event parameters.

### CROSS-REFERENCE TO RELATED APPLICATIONS

This application claims the benefit of priority to U.S. Provisional Patent Application No. 63/723,930 , filed Nov. 22, 2024, the entire contents and disclosures of which are hereby incorporated herein by reference in their entirety.

### FIELD OF DISCLOSURE

The present disclosure generally relates to a centralized calendar event platform, and, more particularly, to machine-learning based systems and methods for retrieving calendar event data from input data of one or more input data types and for identifying data sources for providing additional input data for generating calendar events for storage within a centralized calendar memory.

### BACKGROUND

Calendar management systems may often rely on manual input to create and maintain calendar events. Users may actively input event details such as dates, times, locations, and participants. However, as users engage with multiple devices and applications, tracking and organizing events across different platforms may become cumbersome and prone to human error. For example, a user may schedule a meeting via email, receive a calendar invite on a separate application, and log notes for the same meeting on a third platform. The disjointed nature of these interactions may make it difficult for users to keep their schedules synchronized and accurate. This problem may be further complicated when there are updates to already scheduled events.

Conventional calendaring techniques often may involve significant manual effort, lack real-time data integration, fail to address different data formats, and fail to leverage modern machine learning technologies for event identification and management. These inefficiencies may lead to a fragmented user experience, potential scheduling conflicts, and missed opportunities to optimize productivity. Conventional techniques may include additional inefficiencies, encumbrances, ineffectiveness, and/or other drawbacks.

### BRIEF SUMMARY

The present embodiments may relate to, inter alia, computer systems and computer-based methods for automated event generation and calendar management. In one exemplary embodiment, the event system and method may use at least one machine learning model to analyze (text and/or image analysis) user input data from one or more user devices to identify potential events. These events may include meetings, appointments, or other time-based activities derived from user interactions, such as emails, text messages, data postings, images, video, audio, and/or unstructured data communicated to a user. The identified events are then processed to generate calendar entries, which may include event details such as time, location, participants, and relevant notes. The event system and method may also include identifying missing data associated with the event from the received user data, and causing an automated search to be conducted for additional data to supplement the user data. The event system may then generate a calendar event that includes the user data and the supplemental data that is then saved in a centralized location with the data stored in a common, uniform format.

For example, in exemplary embodiments, a computer system may be configured for generating calendar events using machine learning tools and input data that includes one or more data types received over one or more channels of communication. The system may receive input data from a user device. This input data may include one or more data types. For example, the input data may include structured data, unstructured data, or a combination thereof, may include data of different formats (e.g., text, audio, image, and/or video data), and may include data received via different communication channels (e.g., input and/or captured live by the user device and/or received from an app, web source, and/or other external source). To integrate these various type of data into a format that enables for electronic calendar event generation, the system may input the input data into a machine learning model (e.g., trained based upon historical input data and historical event data) to identify at least some event data included within the input data and may cause the machine learning model to extract the event data from the input data. This event data may be associated with defining an event and may be used to generate an electronic calendar event.

In some cases, the system may determine that additional data is needed to fully define the event. To do so, the system may, using the machine learning model, determine that the event data includes event parameters that only partially define the event. For example, a location, time, and/or other event parameter necessary or useful for defining the event may be missing or unextractable from the initially provided input data. In these cases, the system may cause the machine learning model to retrieve at least one of the additional event parameters by searching additional data sources for the additional event parameters, such as a user profile or web source that includes historical event data and/or other data based upon which the system can predict the additional event parameters. Once all the appropriate event data including the initially identified event parameters and the additionally collected event parameters are collected and/or generated, the system may generate a calendar event based upon these event parameters.

Further, the event system and methods may integrate event data into a centralized dashboard application, accessible across multiple user devices. This dashboard may provide real-time updates, allowing users to view and manage their schedules seamlessly. In some embodiments, the event system may generate additional data based upon incomplete event information, such as suggesting times or locations, by leveraging sensor data or user input. Additionally, the event system may identify related users or participants and generate invitations or notifications to ensure all stakeholders are informed of the event.

The embodiments described herein may also utilize advanced data analysis to enhance scheduling accuracy and efficiency. For example, by identifying pre-existing calendar events, the system may prevent conflicts and automatically update events with new information. Moreover, the system may be configured to generate and train machine learning models using historical event data to improve event prediction and scheduling recommendations, and provide a more intelligent and adaptive calendaring solution. For example, when the system determines the event data is incomplete, the machine learning model may be trained to identify the missing information. The machine learning model may be configured to extrapolate the incomplete event data to identify additional event information. In this way, the system ensures that each event includes all relevant information. The machine learning model may also be trained to conduct automated searches including where to search (e.g., URLs or other locations accessible by computing devices) for certain missing information to supplement the calendar event relative to the user.

The event system may generate an event for each detected event identified. The event is defined as including a common framework which includes event data which are common across each instance of the event.

The event system may include an event generation server that may be communicatively coupled to a database or other memory in which the event generation server stores the generated events in a common format. The event system may be configured to translate disparate event data having different formats into a common format for easy storage, retrieval, and management of that data.

In one aspect, a computer system for generating calendar events using machine learning tools and input data that includes one or more data types received over one or more channels of communication may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, machine learning models, ChatGPT or ChatGPT-based bots, and/or other electronic or electrical components, which may be in wired or wireless communication with one another. For example, in one instance, the computer system may include at least one processor and/or associated transceiver in communication with at least one memory device and in further communication with one or more user computing devices. The at least one processor may be programmed to: (1) receive input data from a user device of the one or more user computing devices, wherein the input data includes one or more data types; (2) input the input data into a machine learning model to identify at least some event data included within the input data, the event data associated with defining an event; (3) cause the machine learning model to extract the event data from the input data; (4) using the machine learning model, determine that the event data includes event parameters that only partially define the event; (5) using the machine learning model, identify additional event data that includes additional event parameters needed to completely define the event; (6) cause the machine learning model to retrieve at least one of the additional event parameters by searching additional data sources for the additional event parameters; and/or (7) generate a calendar event based upon the event parameters and the additional event parameters. The computer system may have additional, less, or alternate functionality, including that discussed elsewhere herein.

In another aspect, a computer-implemented method for generating calendar events using machine learning tools and input data that includes one or more data types received over one or more channels of communication may be provided. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality (XR) glasses or headsets, voice bots or chatbots, machine learning models, ChatGPT or ChatGPT-based bots, and/or other electronic or electrical components, which may be in wired or wireless communication with one another and function as input and/or output devices. For example, in one instance, the computer-implemented method may be implemented by a computer system including at least one processor and/or associated transceiver in communication with at least one memory device and in further communication with one or more user computing devices. The method may include: (1) receiving, by the at least one processor, input data from a user device of the one or more user computing devices, wherein the input data includes one or more data types; (2) inputting, by the at least one processor, the input data into a machine learning model to identify at least some event data included within the input data, the event data associated with defining an event; (3) causing, by the at least one processor, the machine learning model to extract the event data from the input data; (4) using the machine learning model, determining, by the at least one processor, that the event data includes event parameters that only partially define the event; (5) using the machine learning model, identifying, by the at least one processor, additional event data that includes additional event parameters needed to completely define the event; (6) causing, by the at least one processor, the machine learning model to retrieve at least one of the additional event parameters by searching additional data sources for the additional event parameters; and/or (7) generating, by the at least one processor, a calendar event based upon the event parameters and the additional event parameters. The computer-implemented method may include additional, less, or alternate actions, including those discussed elsewhere herein.

In another aspect, at least one non-transitory computer-readable media having computer-executable instructions embodied thereon for generating calendar events using machine learning tools and input data that includes one or more data types received over one or more channels of communication may be provided. The computer-executable instructions may be executed via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality (XR) glasses or headsets, voice bots or chatbots, machine learning models, ChatGPT or ChatGPT-based bots, and/or other electronic or electrical components, which may be in wired or wireless communication with one another and function as input and/or output devices. For example, in one instance, the computer-executable instructions may be executed by a computer system including at least one local or remote processor and/or associated transceivers in communication with at least one local or remote memory device and in further communication with one or more user computing devices. The computer-executable instructions may direct or cause the at least one processor to: (1) receive input data from a user device of the one or more user computing devices, wherein the input data includes one or more data types; (2) input the input data into a machine learning model to identify at least some event data included within the input data, the event data associated with defining an event; (3) cause the machine learning model to extract the event data from the input data; (4) using the machine learning model, determine that the event data includes event parameters that only partially define the event; (5) using the machine learning model, identify additional event data that includes additional event parameters needed to completely define the event; (6) cause the machine learning model to retrieve at least one of the additional event parameters by searching additional data sources for the additional event parameters; and/or (7) generate a calendar event based upon the event parameters and the additional event parameters. The non-transitory computer-readable media may direct additional, less, or alternate functionality, including that discussed elsewhere herein.

In another aspect, a computer system for generating calendar events may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, machine learning models, ChatGPT or ChatGPT-based bots, and/or other electronic or electrical components, which may be in wired or wireless communication with one another. For example, in one instance, the computer system may include at least one processor and/or associated transceiver in communication with at least one memory device and in communication with a user device associated with a user. The at least one processor may be programmed to: (1) receive user data from a user device of the one or more user computer devices; (2) execute a machine learning model to identify an event from the user data including extracting event data from the user data; (3) detect, using the machine learning model, incomplete event data from the user data; (4) generate additional event data with the machine learning model, wherein the additional event data is based upon a user profile; (5) generate a calendar event based upon the event data and the additional event data; (6) generate a prompt corresponding to the calendar event; (7) present, on the user device, the prompt corresponding to the calendar event, (8) receive the additional user data from the user computer device; (9) generate, with the machine learning model, an updated event based upon the additional user data; (10) upload the event data of the updated event to a database including a dashboard application; (11) store the updated event on the database, the database in communication with a plurality of users; and/or (12) display the calendar event on the dashboard application for each user associated with the updated event, wherein the dashboard is configured to execute on the user computer device. The computer system may have additional, less, or alternate functionality, including that discussed elsewhere herein.

In another aspect, a computer-implemented method for generating calendar events may be provided. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality (XR) glasses or headsets, voice bots or chatbots, machine learning models, ChatGPT or ChatGPT-based bots, and/or other electronic or electrical components, which may be in wired or wireless communication with one another and function as input and/or output devices. For example, in one instance, the computer-implemented method may be implemented by a computer system including at least one processor and/or associated transceiver in communication with at least one memory device and in communication with a user device associated with a user. The method may include: (1) receiving user data from a user device of the one or more user computer devices; (2) executing a machine learning model to identify an event from the user data including extracting event data from the user data; (3) detecting, using the machine learning model, incomplete event data from the user data; (4) generating additional event data with the machine learning model, wherein the additional event data is based upon a user profile; (5) generating a calendar event based upon the event data and the additional event data; (6) generating a prompt corresponding to the calendar event; (7) presenting, on the user device, the prompt corresponding to the calendar event, (8) receiving the additional user data from the user computer device; (9) generating, with the machine learning model, an updated event based upon the additional user data; (10) uploading the event data of the updated event to a database including a dashboard application; (11) storing the updated event on the database, the database in communication with a plurality of users; and/or (12) displaying the calendar event on the dashboard application for each user associated with the updated event, wherein the dashboard is configured to execute on the user computer device. The method may include additional, less, or alternate actions, including those discussed elsewhere herein.

In yet another aspect, at least one non-transitory computer-readable media having computer-executable instructions embodied thereon may be provided. The computer-executable instructions may be executed by a computer system including at least one local or remote processor and/or associated transceivers in communication with at least one local or remote memory device and in communication with a user device. The computer-executable instructions may direct or cause the at least one processor to: (1) receive user data from a user device of the one or more user computer devices; (2) execute a machine learning model to identify an event from the user data including extracting event data from the user data; (3) detect, using the machine learning model, incomplete event data from the user data; (4) generate additional event data with the machine learning model, wherein the additional event data is based upon a user profile; (5) generate a calendar event based upon the event data and the additional event data; (6) generate a prompt corresponding to the calendar event; (7) present, on the user device, the prompt corresponding to the calendar event, (8) receive the additional user data from the user computer device; (9) generate, with the machine learning model, an updated event based upon the additional user data; (10) upload the event data of the updated event to a database including a dashboard application; (11) store the updated event on the database, the database in communication with a plurality of users; and/or (12) display the calendar event on the dashboard application for each user associated with the updated event, wherein the dashboard is configured to execute on the user computer device. The computer system may have additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the computer systems and computer-based methods disclosed therein. It should be understood that each figure depicts an embodiment of a particular aspect of the disclosed systems and methods, and that each of the Figures is intended to accord with a possible embodiment thereof. Further, wherever possible, the following description refers to the reference numerals included in the following figures, in which features depicted in multiple Figures are designated with consistent reference numerals.

There are shown in the drawings arrangements which are presently discussed herein. However, it should be understood that the present embodiments are not limited to the precise arrangements and/or instrumentalities shown herein.

FIG. 1 illustrates an event generation computing system according to an exemplary embodiment of the present disclosure.

FIG. 2 illustrates a schematic diagram of an exemplary event generation server in communication with at least one user device according to an exemplary embodiment of the present disclosure as shown in FIG. 1.

FIG. 3 illustrates a simplified block diagram of an exemplary event generation computer system as shown in FIG. 1 according to an exemplary embodiment of the present disclosure.

FIG. 4 illustrates a simplified block diagram of an exemplary event generation computer system as shown in FIG. 1 with a virtual calendar according to an exemplary embodiment of the present disclosure.

FIG. 5 illustrates an exemplary configuration of a user computer device shown in FIG. 4 according to an exemplary embodiment of the present disclosure.

FIG. 6 illustrates an exemplary configuration of a server computer device according to an exemplary embodiment of the present disclosure.

FIG. 7A depicts a flow chart of an exemplary computer-implemented process for an event generation system for a virtual calendar described as an exemplary embodiment of the present disclosure.

FIG. 7B depicts a flow chart of an exemplary computer-implemented process for an event generation system for a virtual calendar continued from FIG. 7A described as an exemplary embodiment of the present disclosure.

FIG. 8 depicts an exemplary machine learning system for generating calendar events based upon input data that includes one or more data types received over one or more channels of communication, in accordance with an exemplary embodiment of the present disclosure.

FIG. 9A depicts an exemplary computer-implemented method system for generating calendar events based upon input data that includes one or more data types received over one or more channels of communication, in accordance with an exemplary embodiment of the present disclosure.

FIG. 9B is a continuation of the exemplary computer-implemented method shown in FIG. 9A.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for automatically generating calendar events by identifying events from user input data collected from various data sources and messages using machine learning models. An event refers to an occurrence or activity that may be scheduled on a calendar, and event data refers to information associated with the event, such as time, location, participants, and other relevant details or parameters of the event. As described further herein, the event is detected from user input data, which may include data received from user devices, sensors, and/or applications. The detected event is processed to generate a corresponding calendar event.

For example, in exemplary embodiments, a computer system may be configured for generating calendar events using machine learning tools and input data that includes one or more data types received over one or more channels of communication. The system may receive input data from a user device. This input data includes one or more data types. For example, the input data may include structured data, unstructured data, or a combination of thereof, may include data of different formats (e.g., text, audio, image, and/or video data), and may include data received via different channels (e.g., input and/or captured live by the user device and/or received from an app, web source, and/or other external source). To integrate these various type of data into a format that enables for electronic calendar event generation, the system may input the input data into a machine learning model (e.g., trained based upon historical input data and historical event data) to identify at least some event data included within the input data and may cause the machine learning model to extract the event data from the input data. This event data may be associated with defining an event and may be used to generate an electronic calendar event.

In some cases, the system may determine that additional data is needed to fully define the event. To do so, the system may, using the machine learning model, determine that the event data includes event parameters that only partially define the event. For example, a location, time, and/or other event parameter necessary or useful for defining the event may be missing or unextractable from the initially provided input data. In these cases, the system may cause the machine learning model to retrieve at least one of the additional event parameters by searching additional data sources for the additional event parameters, such as a user profile or web source including historical event data and/or other data based upon which the system can predict the additional event parameters. Once all the appropriate event data including the initially identified event parameters and the additionally collected event parameters is collected and/or generated, the system may generate a calendar event based upon these event parameters.

In exemplary embodiments, the systems and method described herein may be implemented using a computer system that includes at least one processor in communication with at least one memory and in further communication with one or more user computing devices. Additionally, the processor and/or the user computing devices may be in communication with various communication channels that are capable of providing data relevant to the generation of electronic calendar events.

The system may receive input data from a user device of the one or more user computing devices. The input data may include one or more data types, and may be received via various formats. In at least some cases, some of the input data may be received as unstructured data, such as an image (e.g., an image of an event flyer or handwritten information), video and/or audio recording (e.g., a recording of a phone call or person speaking), or an unstructured text (e.g., text message and/or email threads). Additionally, some of the input data may include structured data, such as data received from mobile applications that are preconfigured to integrate with electronic calendars. It should be noted that even in cases where the input data is structured, the input data may be structured in various different formats and therefore may require further processing as described below for integration into a single electronic calendar event. In various examples, the input data may include audio data, image data, video data, text data, email data, text message data, social media interaction data, screen data, sensor data, structured data, unstructured data, and/or data generated by a mobile application. The system may be configured to use natural language processing (NLP) to parse the event data from text or audio input data.

The system may input the input data into a machine learning model to identify at least some event data included within the input data. This event data may associated with defining an event, and may include data such as a location, a date, a time, a duration, invited users, invitation acceptance status, an event type, an event description, scheduling conflicts, navigation information, and/or other information relevant to an event. In cases in which the event data is unstructured and/or structured according to one or more different formats, the machine learning model to extract the event data from the input data. For example, if the input data is formatted as an image and/or video, the machine learning model may execute computer vision and/or optical character recognition (OCR) models to extract the data, or may use NLP to extract the data.

The machine learning model may be trained based upon historical input data and historical event data (e.g., using any of the machine learning techniques described in further detail below), such that the machine learning model may output predictions and/or identifications of event data elements based upon an inputs of different types of input data. As described above, in some cases, the input data may include unstructured data. In these cases, the machine learning model may be trained based in part upon historical unstructured data and historical event data elements associated with the historical unstructured data, such that the machine learning model may identify event data based upon subsequent inputs of similar unstructured data (e.g., using a key word analysis).

The system may, using the machine learning model, determine that the event data includes event parameters that only partially define the event. For example, a date, time, and location of an event may be identified, but a description, participates associated with the event, and/or other relevant information may be missing and/or not capable of extraction from the initially provided input data. In these cases the system may, using the machine learning model, identify additional event data that includes additional event parameters needed to completely define the event and may cause the machine learning model to retrieve at least one of the additional event parameters by searching additional data sources for the additional event parameters. For example, the machine learning model may parse a user profile (e.g., that includes previously-generated calendar events) associated with the user device or web sources to identify event data fulfilling the additional event parameters.

To identify additional event data and/or data sources from which the data may be collected, the machine learning model may be further trained based upon historical event data and historical data sources associated with the event data. For example, if input data indicates a softball game is scheduled at a certain time but the location is unknown, the machine learning model may predict the location based upon previous calendar events associated with the user device relating to softball games, which may indicate previous locations of the games and/or previous sources that were used to determine the locations of the games (e.g., the locations were determined in past based upon information from a third-party website). In some embodiments, the system may present an additional prompt, via the user device, requesting input of at least one of the identified additional event parameters or to confirm an additional event parameter identified by the machine learning model, and may update and/or further train the machine learning model based upon a response received to this prompt.

The system may generate a calendar event based upon the event parameters extracted from the input data and the additional event parameters extracted from the additionally identified sources. In some cases, the system may determine that the input data corresponds to an already-existing calendar event, in which case the system may update the already-existing calendar event based upon the event data extracted from the input data and/or other identified data sources. The generated and/or updated calendar event may be stored in the memory and/or by the user device, and may be presented, viewed, or otherwise accessed, for example, using an application executing on the user device. In some cases, the generated calendar event may also be accessible to the public and/or to other specified users (e.g., users that are specified by the event parameters that define the event and/or are otherwise determined based upon the event data), which may be identified using the machine learning model.

The systems and methods described herein overcome the deficiencies of other known systems, as described in greater detail herein. In one exemplary embodiment, the process may be performed by an event generation system. In the exemplary embodiment, the event generation system may include a web server associated with, for example, a calendaring service provider. The event generation system may process a variety of user data associated with potential events. The volume and variety of the user data from a variety of data sources may result in a large amount of unstructured information for processing. For example, user data may include hundreds or thousands of data points including text, images, audio and/or video data and may require processing and translation for event detection and subsequent event generation. The system may also execute machine learning and natural language processing techniques to parse unstructured data more intelligently. For example, context-aware language models, pattern-recognition algorithms, or any other suitable methods of machine learning and natural language processing may be used herein. The flexibility of the design ensures that various ML/NLP approaches can be integrated or refined over time, preserving strategic latitude for future enhancements.

In the exemplary embodiment, the event generation system may receive a variety of user data from multiple sources, including but not limited to emails, text messages, social media interactions, application usage data, screen data, and sensor data from user devices. For example, the event generation system may receive user data including an email from a first user device and a text from a second user device. The user data may include any information generated or received by user devices that may indicate potential events. Moreover, different event indicators may be present within the user data, which share common characteristics and may form a basis for detecting specific types of events across the user data. For example, an event indicator may include a meeting invitation received via email. When similar invitations are received by the user, these may be considered instances of the same event type, as they contain common patterns but differ in specific details. Further, the event type includes any group of events which share similar characteristics and therefore may be processed using similar methods. Managing the event data across each instance enables the system to verify, detect, and update the event as additional user data is received.

When the user data includes multiple types of information (e.g., email, text, screen data, and/or unstructured data), it may complicate event detection. Further, each source of the information may include additional data. The event generation system may be programmed to execute the machine learning module to scan the user data to identify the event. Further, the machine learning module may perform a keyword search on the identified event data to identify the event. Each instance of the event may be detected corresponding to the identified user data. In various embodiments, the identified user data is processed by the event generation system to identify an event type. The event type may be determined by the event generation system using artifacts within the user data that correspond to the type of event. Processing the user data to detect the event indicators ensures event data, such as new events and updates to the events, are processed by the event system. In various embodiments, the updates to the event may include additional details about the event, changes in time or location, or other users associated with the event. The event generation system utilizes the event indicators that are identified within the user data wherein each indicator may correspond to a particular event type. This may allow for the streamlining of automatic processing and generation of calendar events.

The event generation system may include an event detection server or computing device. Initially, the event detection server receives user input data from one or more user devices. The event detection server may include a data analysis module. The data analysis module may be configured to process the user input data and identify potential event indicators. The event indicators may include information within the user input data indicating a possible event. The user input data may include static data elements, which remain consistent across different data sources, as well as dynamic data elements, which vary depending on the context. Examples of static data elements may include standard phrases like: “Meeting Invite,” “Appointment Confirmation,” or “Event Reminder.” The dynamic data elements, such as specific times, dates, locations, or participants, are contextually responsive to the static data elements and may change across instances.

In various embodiments, the event detection system may be deployed on the user device. The event detection server may process the user information utilizing computer vision methods and/or text recognition to detect the event. For example, the event detection system captures user input data including screen data to identify the event. However, the screen data may include various forms of unstructured and/or incomplete user data (e.g., text data, image data, audio and/or video data).

The computer vision methods enable the event to be detected across the various forms of data. For example, the machine learning module may execute computer vision methods to scan the user data and perform a key word analysis to identify the event. In the exemplary embodiment, the event detection module identifies and extracts data elements (e.g., the content of static data elements themselves) and their contextual relationships within the user data for each event indicator. The contextual relationship may be defined by metadata, such as timestamps, sender or receiver information, or data source identifiers. In some cases, a data field may be defined for each data element, including attributes like data type and relevance score. In one embodiment, key-value pairs are used to represent the data elements and their associated attributes, which together provide a structured representation of the event indicator with minimal data points.

The event generation system may further include an event analysis module. The event analysis module may group similar instances of an event together. In various embodiments, the event may include a collection of event indicators that share common attributes or patterns. The event may be stored as one or more records in a database or as entries in a data structure, representing all the event indicators contained within the event. The data entries may include a user reference, which may identify the user associated with the event indicator, and the corresponding data elements and contextual information of the event.

In various embodiments, thresholds or criteria are generated by the analysis module to group the event indicators. The thresholds and criteria may be defined by the user or customized for the system. In some instances, a similarity score may be calculated based upon shared attributes, such as matching keywords, timestamps, or locations, to determine whether instances of event data correspond to the same event. Similarly, variations in phrasing or minor discrepancies may be included or excluded when comparing data elements of the event.

The event generation system may further leverage a machine learning model within the event analysis module to enhance the processing of the event data. The machine learning model may analyze the detected event data, identify patterns, and generate additional event-related information. For example, when event data includes only a location reference, the machine learning model may infer and append complementary details such as the specific time, address, or other relevant context. When conflicting event data (e.g., overlapping times or mismatched locations) arise from different data sources, the event generation system may identify the most reliable version of the event data using automated validation checks or confidence scores. If the conflict of the event data remains unresolved, the event generation system may prompt the user to confirm or correct the conflicting event data, ensuring that the resulting calendar event reflects the most relevant and accurate information. The machine learning model may operate by training on historical event data to recognize correlations between incomplete event indicators and their associated details. Through this training, the system may predict missing elements with a high degree of accuracy. Additionally, the machine learning model may account for variations in data inputs, such as incomplete or ambiguous entries, by generating probabilistic matches based upon learned patterns. In some embodiments, the machine learning model continuously refines its predictions through feedback mechanisms, where user input or corrected data may be incorporated into its learning process. This iterative approach enhances the model's accuracy and adaptability, enabling the system to dynamically adjust to evolving data patterns or user preferences.

In some embodiments, the machine learning model may interact with an external source to determine additional event data. Moreover, the machine learning model may identify previous events and provide additional event data such as updates or further details about the past event. For example, if the past event required a ticket, the system may prompt the user about their satisfaction of the event (e.g., whether the user was satisfied with their seating and if they would prefer the same seats in future bookings). Processing the additional user data based upon the prompt enables the system to recommend similar future events. Further, if the event was a sporting event (e.g., a child's sporting event), the machine learning model may crawl web sources to obtain the game's score, track the team's wins and losses, and may prompt the user for input on how the team performed. These notes could then be stored and produced later as requested or pushed to the user when scheduled to play that particular team later in the season.

The event generation system may analyze each of the instances of an event to determine the relevant event data for the calendar event. The analysis of the grouped events may include comparing instance data across the instances of the event. For example, the comparison may determine a substantial match that indicates that the event instances correspond within an accepted degree or threshold level of confidence. The substantial match may be defined by a threshold number or percentage of similarity between two event arrays. Further, the substantial match may be defined by the thresholds or criteria for grouping the event data. The substantial match may include at least a portion of the event data.

A substantial match between two or more event arrays may represent that the associated event indicators correspond to the same or similar events, or, in other words, that they may be classified as an event. The substantial match may also be used to validate event data. For example, substantial matches across multiple instances confirm the validated event data. Further, when there is no substantial match between instances of the event, the system may further process the instance of the event to determine if there is an event update. For example, when an update is received for an existing event, the event generation system detects the substantial match between the instances of the event. The event generation system may process each instance of the substantial match to determine which instance may include the relevant event data. The event generation system may generate an updated event that may include the relevant data for the event corresponding to the update. When the system detects one or more threshold criteria a calendar event may be generated.

In various embodiments, the threshold criteria may include an event match parameter. The event match parameter generally refers to an amount of shared attributes between two or more event instances. The attributes are aggregated for each event indicator. The event parameter may be analyzed by comparing the attribute parameter of each instance to the pre-defined threshold criteria. The event parameter may be user-defined. When the event indicators meet or exceed the event parameter, the event may be generated. The event generation module generates a calendar event for each event identified from the user data.

The event generation system may include an event generation server that may be capable of receiving user input data from a user device and generating events for a virtual calendar. In an exemplary embodiment, the event generation server may include a processor and a memory. The event generation server generates an event for each discreet instance of an identified event. The event may be defined as a common framework which includes event data that may be common across various instances of the event. The event generation server may be communicatively coupled to a virtual calendar in which the event generation server stores the generated events. In some embodiments, the event generation system tracks incremental changes to each event, maintaining a revision log that captures historical times, locations, or other details of the instances associated with the event. The event generation system determines which version of the detected event data is relevant by merging multiple instances of the event or discarding conflicting event data as needed to generate the event. The verification process of the event generation system enhances the determination of correct and relevant details, while ensuring that outdated data can still be retrieved or analyzed when necessary.

The event generation server may also store or cache intermediate values used during the generation of the events. For example, the event generation server may process the user input data and store each instance of the event data in the event generation server. The event data includes at least a portion of the user input data associated with the instance of the event. The event generation server may utilize computer vision to analyze the user input data to detect the instance of the event. The event generation system processes various forms of unstructured user data, introducing challenges related to consistently identifying the event data across various forms of user data. Implementing computer vision to review the user data provides increased accuracy and consistency of event detection by leveraging pattern recognition and feature extraction within the unstructured user data.

For each instance of the event, the event generation server extracts and stores parameters corresponding to the detected event data and/or the additional event data associated with each instance of the event. The event generation server may generate an event ID value which may be stored in the database entry for each instance of the event. Additionally, or alternatively, the event identification module creates a separate table to store information for each identified event. The event identification module stores the text blocks, clusters, and templates in the database.

The event generation server continuously receives user input data, identifies event data, and generates new events. As new event data is detected, event generation server identifies the event data and determines instances of an event based upon one or more detected events according to the event data and/or the additional event data. However, prior to generating new events, event generation module first checks to see if at least a portion of the detected event data identically or substantially match any existing event instances. If no matching event instances are found, event generation server continues according to the process previously describes, and the event data may be analyzed to identify matching instances and new events.

Because the system process various types of user data to identify the event data, the event generation server provides a centralized event generation system across all user input data, resulting in accurate scheduling and improved calendaring across various user data as compared to other known systems. Known methods of calendaring events based upon user input data require individual detection or manual input for the event data.

The methods and systems described herein may be implemented using computer programming or engineering techniques including computer software, firmware, hardware or any combination or subset thereof, wherein the technical effect may be achieved by performing at least one of the following actions or operations: (1) receiving user input data from a user device of the one or more user computer devices; (2) executing a machine learning model to identify an event from the user input data including extracting event data from the user input data; (3) detecting, using the machine learning model, incomplete event data from the user input data; (4) generating additional event data with the machine learning model, wherein the additional event data is based upon the user profile; (5) generating a calendar event based upon the event data and the additional event data; (6) generating an indication corresponding to the calendar event; (7) presenting, on the user device, the indication corresponding to the calendar event, (8) prompting, with the indication presented on the user computer device, the user to provide other additional user data; (9) receiving the other additional user data from the user computer device; (10) generating, with the machine learning model, an updated event based upon all of the additional user data; (11) uploading the event data of the updated event to a database including a dashboard application; (12) storing the updated event on the database, the database in communication with a plurality of users; and/or (13) displaying the calendar event on the dashboard application for each user associated with the updated event, wherein the dashboard may be configured to execute on the user computer device.

More generally, a technical effect of the systems and methods described herein may include improvements in leveraging technology such as machine learning tools and/or other artificial intelligence-based rules to improve the speed and accuracy of automated event generation and calendar management. The system may translate various data relating to scheduled events including meetings, appointments, or other time-based activities derived from user interactions, such as emails, text messages, data postings, images, audio, video and/or unstructured data communicated to a user. And store this translated data in a centralized database for easy storage, management, and retrieval.

The event system and method may also include identifying missing data associated with the event from the received user data and may then utilize the machine learning models to cause an automated search to be conducted for additional data to supplement the user data. The event system may then generate a calendar event that includes the user data and the supplement data that may be then saved in a centralized location with the data stored in a common format. The methods and systems described herein may be implemented using computer programming or engineering techniques including computer software, firmware, hardware, or any combination or subset thereof.

### Event Generation System

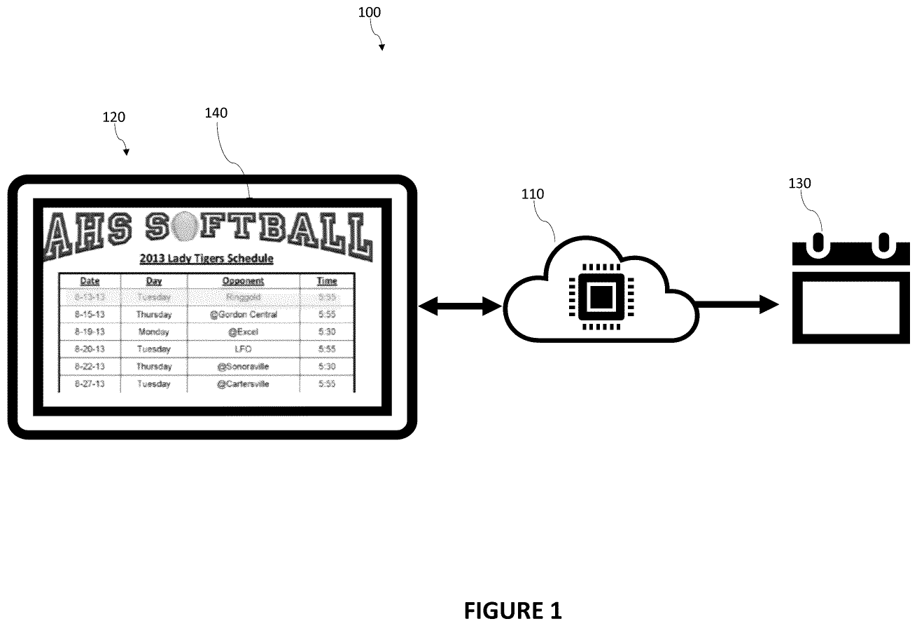

FIG. 1 illustrates an exemplary embodiment of an event generation system 100. The event generation system 100 may include an event generation computing device 110 that may be in communication with one or more user devices 120 and one or more virtual calendars 130. In some embodiments, the virtual calendar 130 may be integrated into the event generation computing device 110, functioning as a central interface for event management. The event generation computing device 110 continuously monitors user devices 120 to capture various types of user input data 140, such as screen data and/or other user input data 140. The user input data 140 may be then processed by the event generation computing device 110, which employs algorithms or machine learning models to analyze the captured information and detect relevant event data. In certain implementations, the event generation system 100 may integrate with external calendar services, mapping or location platforms, ticketing websites, or other APIs to supplement the event data. The event generation system may enable or customize the external integrations at the user's discretion, allowing preferences to dictate how and when third-party data is retrieved. For example, event addresses might be auto-populated using a location service, or seat details could be obtained directly from a ticket provider.

When the event generation computing device 110 detects user input data 140 corresponding to an event, the event generation computing device 110 generates a corresponding event entry and displays it on the virtual calendar 130. The virtual calendar 130 not only serves as a visual representation of scheduled events but also allows users to interact with and manage these events. For example, users may view event details, edit event attributes, or associate additional contextual information, such as documents or notes, directly within the calendar interface.

Furthermore, the event generation computing device 110 may provide intelligent suggestions or reminders based upon detected patterns or user behavior. For instance, if the event generation computing device 110 identifies a recurring event type, it may automatically populate relevant fields, such as time, location, or associated participants, to streamline event creation. This integration enhances user productivity by consolidating event management and related data into a single, accessible platform. In various embodiments, the event generation computing device 110 may generate the indications for newly identified or time-sensitive events, prompting the user to confirm details before finalizing them on the calendar. In addition, notifications or reminders can be pushed to the user device for upcoming events. Optional features include location-based alerts or voice-activated commands to capture data on the fly, offering flexible interaction channels without constraining the system to any single interface approach.

The event generation computing device 110 may be in communication with one or more user devices 120 and one or more virtual calendars 130. The virtual calendar 130 may be incorporated into the event generation computing device 110. The event generation computing device 110 monitors the user device 120 to capture user input data 140. The captured user data 140 may be processed by the event generation computing device 110 to detect event data. When an event is detected, the event generation system 100 may generate the events and displays them on the virtual calendar 130.

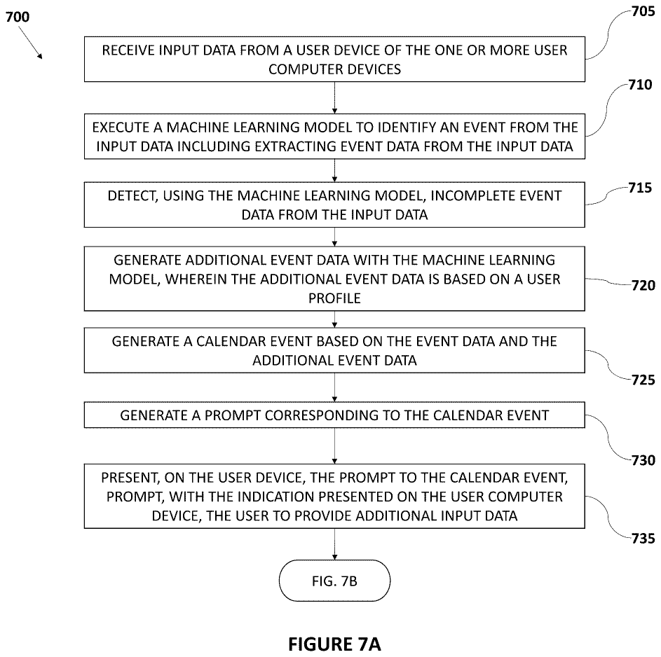

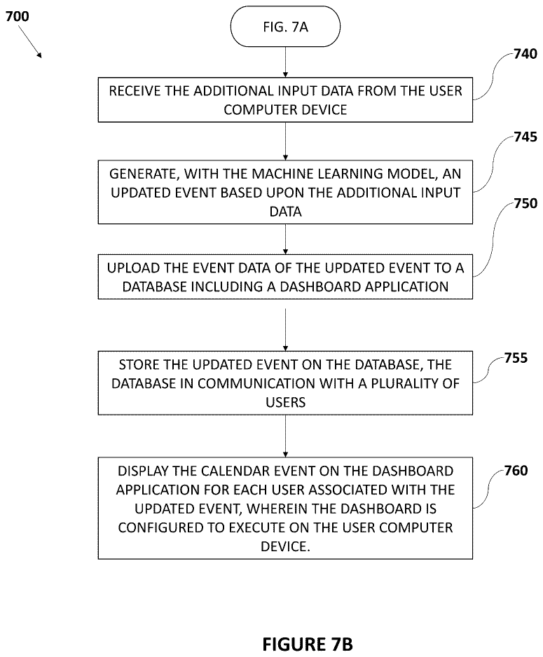

The event generation computing device 110 may be configured to implement process 700, shown in FIGS. 7A and 7B. As described below in more detail, event generation computing device 110 may include a computing device configured to receive user input data, identify event data, and generate an event based upon the event data.

### Event Generation Server

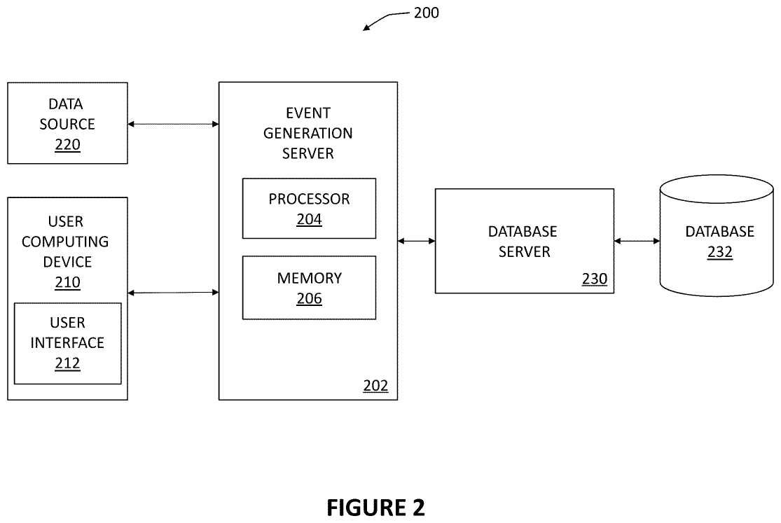

FIG. 2 is a schematic diagram of a more detailed exemplary embodiment of an event generation system 200 similar to the event generation system 100 shown in FIG. 1. Event generation system 200 may include event generation computing device or event generation server 202 which may be in communication with at least one, but more likely many, user computing devices 210 that includes a user interface 212. Event generation server 202 may include at least one processor 204 and at least one memory 206. User computing devices 210 may be associated with a human or other users interacting with user computing device 210. The user of user computing device 210 may be prompted by the event generation server 202 (e.g., an indication provided by the event generation server 202) to generate an event via user interface 212 of user computing device 210 when an event is detected. In the exemplary embodiment, user computing devices 210 are computers that include a web browser or a software application, which enables user computing devices 210 to access remote servers, such as event generation server 202, the Internet, or other networks. More specifically, user computing devices 210 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

User computing device 210 may be a device capable of accessing the Internet including, but not limited to, a desktop computer, a laptop computer, a personal digital assistant (PDA), a cellular phone, a smartphone, a tablet, a phablet, wearable electronics, smart watch, or other web-based connectable equipment or mobile devices. User computing device 210 may be a personal computing device and/or a mobile communications device of a user, such as a personal computer, a tablet computer, a smartphone, and the like. User computing devices 210 may be configured to present an application (e.g., a smartphone “app”) or a webpage. To this end, user computing device 210 may include or execute software, such as a web browser, for viewing and interacting with a webpage and/or an app. Although one user computing device 210 is shown in FIG. 2 for clarity, it should be understood that event generation system 100 may include any number of user computing devices 210.

Event generation server 202 may also be in communication with a data source 220. Data source 220 may be associated with and/or store unstructured user data, such as screen data requiring further processing on event generation server 202. Data source 220 may be a computing device as described above that may be capable of transmitting the user input data to event generation server 202. Alternatively, event generation server 202 may receive user input data from user computing device 210.

In various embodiments, event generation server 202 may be directly coupled to a database server 230 and/or communicatively coupled to database server 230 via a network. Event generation server 202 may, in addition, function to store, process, and/or deliver one or more web pages and/or any other suitable content to user computing device 210. Event generation server 202 may, in addition, receive data, such as data provided to the app and/or webpage (as described herein) from user computing device 210 for subsequent transmission to database server 230.

In some embodiments, event generation server 202 may be associated with, or is part of, a computer network associated with a user, or in communication with user network computing devices. In other embodiments, event generation server 202 may be associated with a third party and is merely in communication with the user computing devices. Database server 230 may be a computer or computer program that provides database services to one or more other computers or computer programs. Database server 230 may function to process data received from event generation server 202. In some embodiments, the event generation server 202 may run entirely on a central server, partially on user devices, or in a hybrid arrangement, depending on deployment needs. This flexible architecture may scale to enterprise-level usage, potentially employing load balancing, distributed databases, or edge-computing principles to accommodate large volumes of user data. Database 232 may be any organized collection of data, such as, for example, any data organized as part of a relational data structure, any data organized as part of a flat file, and the like. Database 232 may be communicatively coupled to database server 230 and may receive data from, and provide data to, database server 230, such as in response to one or more requests for data, which may be provided via a database management system (DBMS) implemented on database server 230, such as SQLite, PostgreSQL (e.g., Postgres), or MySQL DBMS. Database 232 may be a scalable storage system that includes fault tolerance and fault compensation capabilities. Data security capabilities may also be integrated into database 232. In one embodiment, database 232 may be Hadoop® Distributed File System (HDFS). In other embodiments, database 232 may be a non-relational database, such as APACHE Hadoop® database.

In the exemplary embodiment, database 232 may include various data, such as user input data, the data associated with instances of the event associated therewith, as well as event data and generated events, as described in further detail herein. In the exemplary embodiment, database 232 may be stored remotely from event generation server 202. In some embodiments, database 232 may be decentralized. In the exemplary embodiment, a user may access database 232 via user computing devices 210 by logging onto event generation server 202, as described herein.

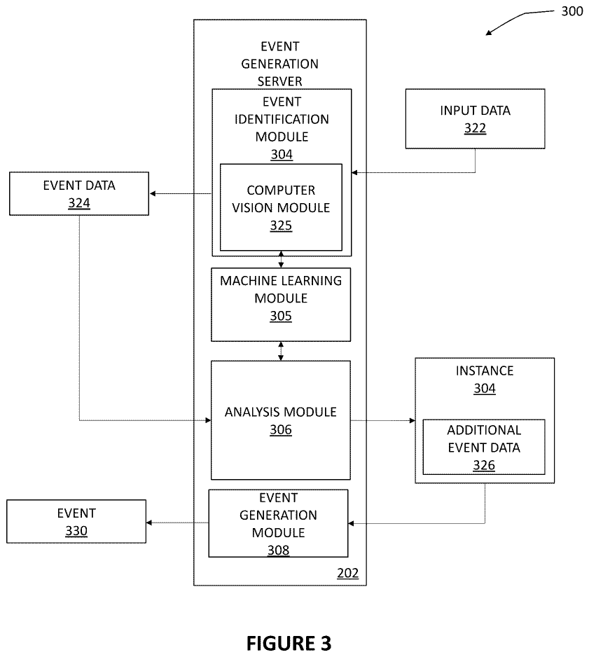

FIG. 3 is a diagram that illustrates event generation system 300 (similar to the systems shown in FIGS. 1 and 2) including event generation server 202 in further detail. Event generation server 202 may include an event identification module 304, a machine learning module 305, a computer vision module 325, an analysis module 306, and an event generation module 308. These modules may be implemented or executed using processor 204. Further, the modules of the event generation server may be in communication with one or more additional modules of the event generation server 202.

Event identification module 304 receives input data 322, which may include user data and/or other types of data, from data source 220 or user computing device 210, as shown in FIG. 2. As described above, the input data 322 may be unstructured data and/or structured data. Event identification module 304 may process the user data using a computer vision module 325. The computer vision module 325 may be connected to the machine learning module 305. The computer vision module 325 analyzes the input data 322 to parse and extract event data 324. Event data 324 may include input data 322 indicating a possible instance of an event. Event analysis module 306 receives the event data 324, from the event identification module 304 and compares the event data 324 against any corresponding instance of the event data 324. The analysis module 306 identifies corresponding instances of the event data 324 based upon identical or substantially matching elements of the event data associated with at least one additional instance of an event 330. The analysis module and combines the event data 324 with the associated instance of the event 330.

Matches between elements of the event data 324 may include a partial match. A partial match includes event data elements that substantially match, but accounts for inaccuracies introduced through the unstructured user data. In the exemplary embodiment, a partial match accounts multiple instances associated with the same event 330. The analysis module 306 may be further configured to combine the event data 324 into the instance associated with the event 330. In various embodiments, the additional data supplements the data to generate complete event data 324. Further, the analysis module 306 may be configured to identify incomplete data associated with the detected event data 324.

The incomplete data includes event data 324 including a partial description of the event 330. For example, the partial description may lack relevant information for calendaring the event. When the analysis module 306 detects the incomplete data, the machine learning module 305 may be configured to generate additional event data 326. The machine learning module 305 may execute a machine learning model trained on the user's profile and/or additional data sources. The machine learning module 305 generates the additional event data 326 based upon the incomplete event data as it relates to the trained machine learning module 305. For example, the machine learning model processes partial event data 324 and identifies additional data corresponding to the event 330 on an additional data source. The machine learning model may be configured to process additional data from the data source to generate the additional event data 326.

Event generation module 308 then receives each instance 334 of the event and any additional event data 326. Event generation module 308 compares each instance 334 and determines threshold criterion for generating the event, and when the event generation conditions are met, analysis module 306 defines the event 330. Event generation module 308 generates the event 330 corresponding to each instance 334. As shown in FIG. 2, event generation server 202 may be communicatively coupled with database server 230 and database 232. The database 232 stores the events 330, event data 324, instances 334, and the additional event data 326.

In the exemplary embodiment, event generation server 202 may receive input data 322 from user computing device 210 (shown in FIG. 2). Input data 322 may include one or more data types, and may be received via various formats. In at least some cases, some of input data 322 may be received as unstructured data, such as an image (e.g., an image of an event flyer or handwritten information), video and/or audio recording (e.g., a recording of a phone call or person speaking), or an unstructured text (e.g., text message and/or email threads). Additionally, some of input data 322 may include structured data, such as data received from mobile applications that are preconfigured to integrate with electronic calendars. It should be noted that even in cases where input data 322 is structured, input data 322 may be structured in various different formats and therefore may require further processing as described below for integration into a single electronic calendar event. In various examples, input data 322 may include audio data, image data, video data, text data, email data, text message data, social media interaction data, screen data, sensor data, structured data, unstructured data, and/or data generated by a mobile application.

Event generation server 202 may input the input data 322 into a machine learning model to identify at least some event data 324 included within input data 322. This event data 324 may associated with defining an event 330, and may include data such as a location, a date, a time, a duration, invited users, invitation acceptance status, an event type, an event description, scheduling conflicts, navigation information, and/or other information relevant to an event 330. In cases in which event data 324 is unstructured and/or structured according to one or more different formats, the machine learning model to extract event data 324 from input data 322. For example, if input data 322 is formatted as an image and/or video, the machine learning model may execute computer vision and/or optical character recognition (OCR) models to extract the data, or may use NLP to extract the data.

The machine learning model may be trained based upon historical input data and historical event data (e.g., using any of the machine learning techniques described in further detail below), such that the machine learning model may output predictions and/or identifications of event data elements based upon an inputs of different types of input data. As described above, in some cases, input data 322 may include unstructured data. In these cases, the machine learning model may be trained based in part upon historical unstructured data and historical event data elements associated with the historical unstructured data, such that the machine learning model may identify event data 324 based upon subsequent inputs of similar unstructured data (e.g., using a key word analysis).

Event generation server 202 may, using the machine learning model, determine that event data 324 includes event parameters that only partially define event 330. For example, a date, time, and location of an event 330 may be identified, but a description, participates associated with event 330, and/or other relevant information may be missing and/or not capable of extraction from the initially provided input data. In these cases event generation server 202 may, using the machine learning model, identify additional event data 326 that includes additional event parameters needed to completely define event 330 and may cause the machine learning model to retrieve at least one of the additional event parameters by searching additional data sources 220 (shown in FIG. 2) for the additional event parameters. For example, the machine learning model may parse a user profile (e.g., that includes previously-generated calendar events) associated with user computing device 210 or web sources to identify additional event data 326 fulfilling the additional event parameters.

To identify additional event data 326 and/or data sources 220 from which the data may be collected, the machine learning model may be further trained based upon historical event data and historical data sources associated with the historical event data. For example, if input data 322 indicates a softball game is scheduled at a certain time but the location is unknown, the machine learning model may predict the location based upon previous calendar events associated with user computing device 210 relating to softball games, which may indicate previous locations of the games and/or previous sources that were used to determine the locations of the games (e.g., the locations were determined in past based upon information from a third-party website). In some embodiments, event generation server 202 may additional prompt via user computing device 210 requesting input of at least one of the identified additional event parameters or to confirm an additional event parameter identified by the machine learning model, and may update and/or further train the machine learning model based upon a response received to this prompt.

Event generation server 202 may generate a calendar event 330 based upon the event parameters extracted from input data 322 and the additional event parameters extracted from the additionally identified sources. In some cases, event generation server 202 may determine that input data 322 corresponds to an already-existing calendar event 330, in which case event generation server 202 may update the already-existing calendar event 330 based upon event data 324 extracted from input data 322 and/or additional event data 326 other identified data sources 220. The generated and/or updated calendar event 330 may be stored in the memory and/or by user computing device 210, and may be presented, viewed, or otherwise accessed, for example, using an application executing on user computing device 210. In some cases, the generated calendar event 330 may also be accessible to the public and/or to other specified users (e.g., users that are specified by the event parameters that define event 330 and/or are otherwise determined based upon the event data 324 and/or additional event data 326), which may be identified using the machine learning model.

In the exemplary embodiment, event generation system 300 may provide for a secure exchange of event data 324 and/or other data using a virtual calendar. The virtual calendar may enable a user to securely store events 330 and to authorize other users to access events 330. For example, a user may, through input (e.g., within the calendaring system, a mobile app, and/or web page) designate events 330 to be stored in the virtual calendar, or event 330 may automatically be stored in association with the virtual calendar in response to certain events 330. The user may also designate other users to access any of these stored events 330, or the system may determine which individuals to authorize access to certain events 330 stored within the virtual calendar. These authorized users may than retrieve, view, and/or trigger a download of events 330, for example, by accessing the virtual calendar from user computing device 210.

In the exemplary embodiment, event generation system 300 may be configured to communicate with one or more user computer devices to cause those user computer devices to present the virtual calendar associated with a first user. As described in further detail below, access to and/or the appearance of the calendar to a particular user may be controlled based upon whether the particular user may be authorized to access any event data 324 stored in the virtual calendar. The virtual calendar may include and/or be labeled with text or indicators providing information about events 330 on the virtual calendar (e.g., which user is associated with the calendar, a relationship between the viewer and the user may be associated with the calendar, and/or whether the viewer has access to any event data 324 in the virtual calendar).

In the exemplary embodiment, event generation system 300 may be configured to store event data 324 in the memory in association with the virtual calendar. For example, the user may designate event data 324 to store in association with the virtual calendar or event generation system 300 may automatically determine and store or suggest storing or sharing, event data 324 in association with the virtual calendar. In various embodiments, the user may input instructions at a mobile device via a mobile application to store event data 324 in associated with the at least one virtual calendar. The system may then store the one or more generated events 330 in association with the at least one virtual calendar in response to receiving the instruction. In some embodiments, the user may generate input data 322 with user computing device 210 that indicates an intention to store event data 324 in association with the virtual calendar (e.g., dragging and placing, or selecting from a menu). Event generation system 300 may then store event data 324 in association with the virtual calendar in response to receiving this input data 322. In some embodiments, the system may automatically identify event data 324 to store.

In the exemplary embodiment, event generation system 300 may be configured to identify one or more authorized users of the plurality of users to enable access to the at least one virtual calendar. In some embodiments, the user associated with the virtual calendar may select other users to receive authorization. For example, the user may submit instructions at the mobile device via the mobile application instructions to designate one or more users as authorized to access event data 324 of the virtual calendar, and the system may identify one or more authorized users based upon the received instruction.

In the exemplary embodiment, event generation system 300 may be configured to provide access to the event data 324 in response to the identified one or more authorized users interacting with the virtual calendar. For example, the authorized users may open, click, or tap on, or otherwise interact with the virtual calendar, which may enable the authorized users to view, download, share, and/or modify event data 324 of the virtual calendar. Additionally, or alternatively, accessing the documents in the virtual environment may trigger a download or other transfer of data that may enable events 330 to be viewed through a different channel, such as through the mobile app, web page, and/or another type of display device.

### Exemplary Computer Network

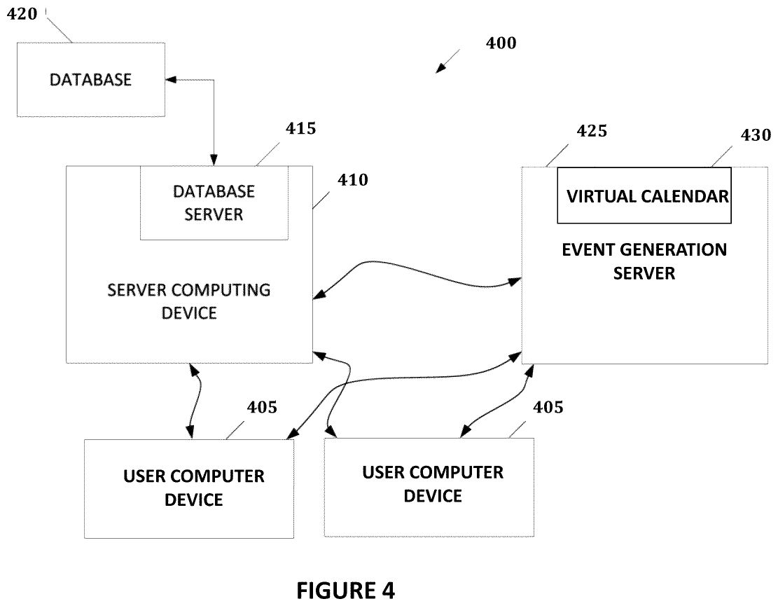

FIG. 4 depicts a simplified block diagram of an exemplary event generation computer system 400, which is similar to the event generation computer system shown in FIGS. 1-3. In the exemplary embodiment, event generation computer system 400 may be used for providing a virtual calendar 430. The event generation computer system 400 may include user computer devices 405. The user computer devices 405 may be computers that include a web browser or a software application, which may enable user computer devices 405 to access server computing device 410 using the Internet. More specifically, user computer devices 405 may be communicatively coupled to the Internet through many interfaces including, but not limited to, at least one of a network, such as the Internet, a local area network (LAN), a wide area network (WAN), or an integrated services digital network (ISDN), a dial-up-connection, a digital subscriber line (DSL), a cellular phone connection, and a cable modem.

User computer devices 405 may be a device capable of accessing the Internet including, but not limited to, a mobile device, a desktop computer, a laptop computer, a personal digital assistant (PDA), a cellular phone, a smartphone, a tablet, a phablet, wearable electronics, smart watch, virtual headsets or glasses (e.g., AR (augmented reality), VR (virtual reality), or XR (extended reality) headsets or glasses), smart glasses, a kiosk, a drone, chat bots, or other web-based connectable equipment or mobile devices.

A database server 415 may be communicatively coupled to a database 420 that stores data. In one embodiment, database 420 may include event data, user information, and/or user preferences. In the exemplary embodiment, database 420 may be stored remotely from server computing device 410 and/or event generation server 425. In some embodiments, database 420 may be decentralized. In the exemplary embodiment, a person may access database 420 via user computer devices 405 by logging onto server computing device 410 and/or event generation server 425, as described herein.

Server computing device 410 may be communicatively coupled with one or more of the user computer devices 405. In some embodiments, server computing device 410 may be associated with or may be part of a computer network associated with an organization (e.g., business, group, school, team, or other user associated network) or in communication with the organization's computer network. In other embodiments, server computing device 410 may be associated with a third party and is merely in communication with the organizations'computer network. One or more event generation servers 425 may be communicatively coupled with server computing device 410. The one or more event generation servers 425 each may be associated with a virtual calendar 430. Event generation servers 425 may provide tools and/or applications for users to access their associated virtual calendar 430 over the Internet.

In the exemplary embodiment, server computing device 410 and/or event generation server 425 may communicate with a user device (e.g., user computer device 405) to cause the user device to present an indication of a detected event. Server computing device 410 and/or event generation server 425 may provide an indication including event data, additional event data, or other instances of the detected event that may be presented to the user by the user device. Server computing device 410 and/or event generation server 425 may receive user input data from the user device, and based upon this received user input data, server computing device 410 and/or event generation server 425 may continually update the virtual calendar 430. For example, the event generation system may respond to the input of the user.

In the exemplary embodiment, server computing device 410 may generate a proposed response to a user based upon received user input data. User input that indicates a response may be required may include questions input by the user. For example, if the user inputs additional event data, server computing device 410 may determine an update to the event on the virtual calendar 430. In some embodiments, user inputs include actions from the user device, such as sending emails, phone messages, screen data, and/or text messages of the user.

In the exemplary embodiment, server computing device 410 may provide for a secure exchange of event data using a virtual calendar mechanism. The virtual calendar 430 may enable a user to securely store events and to authorize other users to access the events. For example, a user may, through input designate events to be stored in the virtual calendar 430, or the events may automatically be stored in association with the virtual calendar 430 in response to certain events. The user may also designate other users to access the events, or server computing device 410 may determine which individuals to authorize access to the events stored within the virtual calendar. These authorized users may than retrieve, view, and/or trigger a download of the events, for example, by accessing the virtual calendar on an additional user computer device.

### Exemplary User Device

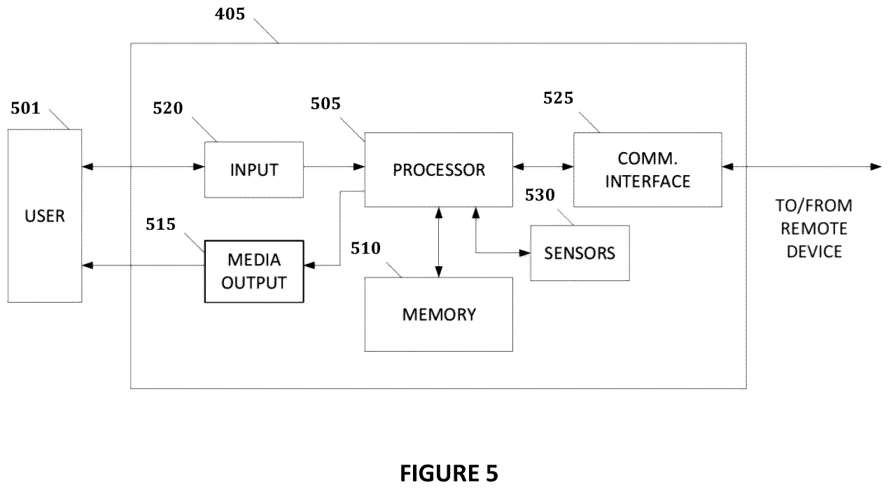

FIG. 5 depicts an exemplary configuration of a user computer device 405 shown in FIG. 4, in accordance with one embodiment of the present disclosure. User computing device 405 may be operated by a user 501. User computing device 405 may include a processor 505 for executing instructions. In some embodiments, executable instructions may be stored in a memory area 510. Processor 505 may include one or more processing units (e.g., in a multi-core configuration). Memory area 510 may be any device allowing information such as executable instructions and/or transaction data to be stored and retrieved. Memory area 510 may include one or more computer readable media.

User computing device 405 may also include at least one media output component 515 for presenting information to user 501. Media output component 515 may be any component capable of conveying information to user 501 regarding the event data. In some embodiments, media output component 515 may include an output adapter (not shown) such as a video adapter and/or an audio adapter. An output adapter may be operatively coupled to processor 505 and operatively couplable to an output device such as a display device (e.g., a cathode ray tube (CRT), liquid crystal display (LCD), light emitting diode (LED) display, or “electronic ink” display), an audio output device (e.g., a speaker or headphones), or other display devices.

Input device 520 may include, for example, a keyboard, a pointing device, a mouse, a stylus, a touch sensitive panel (e.g., a touch pad or a touch screen), a gyroscope, an accelerometer, a position detector, a biometric input device, an audio input device (e.g., a microphone), and/or a video input device (e.g., a camera). A single component such as a touch screen may function as both an output device of media output component 515 and input device 520.

User computing device 405 may also include a communication interface 525, communicatively coupled to a remote device such as server computing device 410 (shown in FIG. 4). Communication interface 525 may include, for example, a wired or wireless network adapter and/or a wireless data transceiver for use with a mobile telecommunications network.

Stored in memory area 510 may be, for example, computer readable instructions for providing a user interface to user 501 via media output component 515 and, optionally, receiving and processing input from input device 520. A user interface may include, among other possibilities, a web browser and/or a client application. Web browsers enable users, such as user 501, to display and interact with media and other information typically embedded on a web page or a website from the server computing device 410 and/or the event generation server 425.

A client application allows user 501 to interact with, for example, the server computing device 410 and/or the event generation server 425. For example, instructions may be stored by a cloud service, and the output of the execution of the instructions sent to the media output component 515. Processor 505 executes computer-executable instructions for implementing aspects of the disclosure. In some embodiments, the processor 505 is transformed into a special purpose microprocessor by executing computer-executable instructions or by otherwise being programmed.

### Exemplary Server Device

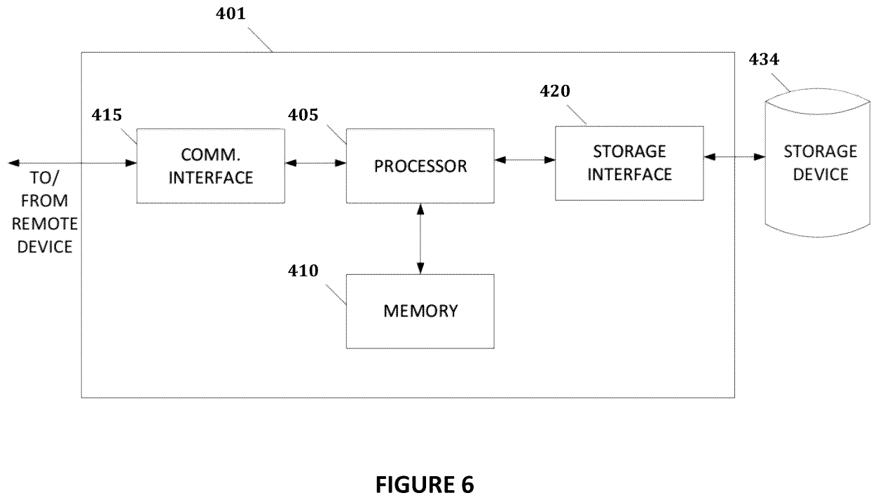

FIG. 6 depicts an exemplary configuration of a server computing device 601, in accordance with one embodiment of the present disclosure. Server computer device 601 may include, but is not limited to, server computing device 410 and/or event generation server 425 (all shown in FIG. 4). Server computing device 601 may also include a processor 605 for executing instructions. Instructions may be stored in a memory area 610. Processor 605 may include one or more processing units (e.g., in a multi-core configuration).

Processor 605 may be operatively coupled to a communication interface 615 such that server computer device 601 is capable of communicating with a remote device such as another server computer device 601, event generation server 425, or user computing devices 405 (shown in FIGS. 4 and 5). For example, communication interface 615 may receive requests from user computer devices 405 via the Internet.

Processor 605 may also be operatively coupled to a storage device 634. Storage device 634 may be any computer-operated hardware suitable for storing and/or retrieving data, such as, but not limited to, data associated with database 420 (shown in FIG. 4). In some embodiments, storage device 634 may be integrated in server computer device 601. For example, server computer device 601 may include one or more hard disk drives as storage device 634.

In other embodiments, storage device 634 may be external to server computer device 601 and may be accessed by a plurality of server computer devices 601. For example, storage device 634 may include a storage area network (SAN), a network attached storage (NAS) system, and/or multiple storage units such as hard disks and/or solid state disks in a redundant array of inexpensive disks (RAID) configuration.

In some embodiments, processor 605 may be operatively coupled to storage device 634 via a storage interface 620. Storage interface 620 may be any component capable of providing processor 605 with access to storage device 634. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 434.

Processor 605 may execute computer-executable instructions for implementing aspects of the disclosure. In some embodiments, the processor 605 may be transformed into a special purpose microprocessor by executing computer-executable instructions or by otherwise being programmed.

### Exemplary Computer-Implemented Method for Generating a Calendar Event

FIGS. 7A and 7B depict a flow chart of an exemplary computer-implemented process 700 for interaction with at least one user in an event generation system 100 as shown in FIG. 1. Process 700 may be implemented by a computing device, for example server computing device 410 and/or event generation server 425 (shown in FIG. 4). In the exemplary embodiment, server computing device 410 may be in communication with one or more event generation servers 425 and one or more user computer devices 405 (both shown in FIG. 4).

In some embodiments, process 700 may include receiving (block 705) user input data from a user computer device of the one or more user computer devices. Process 700 may include executing (block 710) a machine learning model to identify an event from the user input data including extracting event data from the user input data. The process 700 may also include detecting (block 715), using the machine learning model, incomplete event data from the user input data. Process 700 may further include generating (block 720) additional event data with the machine learning model, wherein the additional event data may be based upon a user profile. Process 700 may also include generating (block 725) a calendar event based upon the event data and the additional event data. Process 700 may further include generating (block 730) a prompt corresponding to the calendar event. Process 700 may also include presenting (block 735), on the user device, the prompt corresponding to the calendar event.

Process 700 may also include receiving (block 740) the additional user input data from the user computer device. Process 700 may further include generating (block 745), with the machine learning model, an updated event based upon the additional user input data. Process 700 may also include uploading (block 750) the event data of the updated event to a database including a dashboard application. Process 700 may further include storing (block 755) the updated event on the database, the database in communication with a plurality of users. Process 700 may also include displaying (block 760) the calendar event on the dashboard application for each user associated with the updated event, wherein the dashboard may be configured to execute on the user computer device. In some embodiments, these actions or operations may be performed by server computing device 410 and/or event generation server 425 (shown in FIG. 4).

### Exemplary Machine Learning System

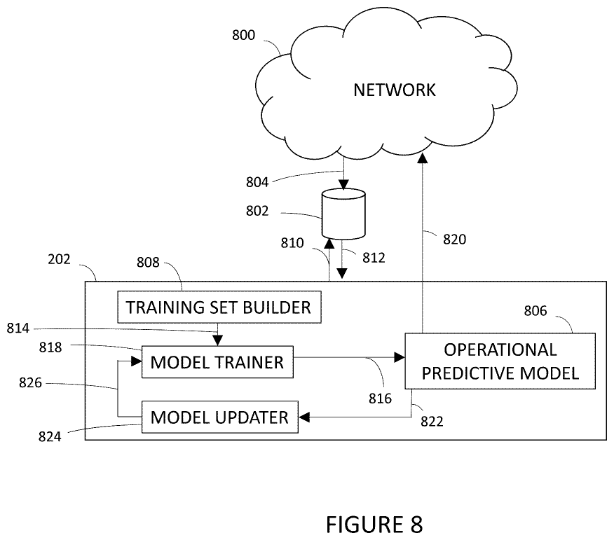

FIG. 8 illustrates an exemplary configuration of machine learning system for generating calendar events based upon input data that includes one or more data types received over one or more channels of communication. At least part of the machine learning system may be implemented as a component of event generation system 200 and may include a computing device such as event generation server 202.

The computing device may include and/or be in communication with a database 802 that stores data 804, such as database 232 (shown in FIG. 2), stored records generated by the computing device, and/or any other relevant data described herein. Data 804 received from network 800 may be stored in database 802. The computing device may be configured to use data 804 to generate an operational predictive model 806 analyzes images and/or other sensor data, for example, for identifying events, identifying event data, identifying event parameters, identifying other sources of data for retrieving event data and/or other data related to generating a calendar event as described herein.

In exemplary embodiments, the computing device may include a training set builder module 808 configured to submit one or more queries 810 to database 802 to retrieve subsets 812 of data 804, and to use those subsets 812 to build training data sets 814 for generating operational predictive model 806. For example, query 810 may be configured to retrieve certain fields from data 804 for a specific feature, a specific category, and/or any other division of factors desired by the user.

In various embodiments, training set builder module 808 may be configured to derive training data sets 814 from retrieved subsets 812. Each training data set 814 corresponds to a historical data 804 (“historical” in this context means completed in the past, as opposed to completed in real-time with respect to the time of retrieval). Each training data set 814 may include “model input” data fields along with at least one “result” data field representing a historical outcome associated with the model input. The model input data fields represent factors that may be expected to, or unexpectedly be found during model training to, have some correlation. In some embodiments, training data sets 814 may include data obtained in real-time (e.g., from user computing device 210 and/or any other data source described herein). For example, training data sets 814 may include historical events, historical event data associated with historical events, and/or historical data sources used to provide event data for historical events.

In exemplary embodiments, the model input data fields in training data sets 814 may be generated from data fields in subset 812 corresponding to historical data 804. In other words, a trained machine learning model 816 produced by a model trainer module 818 for use by AI module (also known as Operational Predictive Model) 806 is trained to make predictions based upon input values that can be generated from the data fields in data 804. Values in the model input data fields may include values copied directly from values in a corresponding data field in the retrieved subset 812, and/or values generated by modifying, combining, and/or otherwise operating upon values in one or more data fields in the retrieved subset 812. The use of such data fields as model input data fields facilitates the machine learning model in weighing these factors directly.

After training set builder module 808 generates training data sets 814, training set builder module 808 passes the training data sets 814 to model trainer module 818. In certain embodiments, model trainer module 818 may be configured to apply the model input data fields of each training data set 814 as inputs to one or more machine learning models. Each of the one or more machine learning models may be programmed to produce, for each training data set 814, at least one output intended to correspond to, or “predict,” a value of the at least one result data field of the training data set 814. “Machine learning” refers broadly to various algorithms that may be used to train the model to identify and recognize patterns in existing data in order to facilitate making predictions for subsequent new input data.

In some embodiments, training set builder module 808 may generate multiple training data sets based upon data received by the computing device. For example, a first training dataset may be generated based upon a first subset of training data, and a second training dataset may be generated based upon a second subset of training data. Training data sets may be used in a staged training process to train one or more machine learning models. For example, a machine learning model may be trained initially on first training dataset, and then subsequently on the second training dataset. Training datasets may be transformed to produce new training datasets. Transformations of data may include applying noise to data or manipulating data. For example, images in a training data set may be mirrored, rotated, smoothed, undergo contrast reduction, resized, cropped, have a noise mask applied, and/or be otherwise manipulated to alter the training data. Other data in the training data set may be manipulated to improve the training of the model(s) to better recognize event data included within input data and to better determine other sources of data needed to access to complete the calendar event.

Model trainer module 818 may be configured to compare, for each training data set 814, the at least one output of the model to the at least one result data field of the training data set 814, and apply a machine learning algorithm to adjust parameters of the model in order to reduce the difference or “error” between the at least one output and the corresponding at least one result data field. In this way, model trainer module 818 trains the machine learning model to accurately predict the value of the at least one result data field.

In other words, model trainer module 818 cycles the one or more machine learning models through the training data sets 814, causing adjustments in the model parameters, until the error between the at least one output and the at least one result data field falls below a suitable threshold, and then uploads at least one trained machine learning model 816 to operational predictive model 806 for application to data analysis 820. In exemplary embodiments, model trainer module 818 may be configured to simultaneously train multiple candidate machine learning models and to select the best performing candidate for each result data field, as measured by the “error” between the at least one output and the corresponding result data field, to upload to operational predictive model 806.

In certain embodiments, the one or more machine learning models may include one or more neural networks, such as a convolutional neural network, a deep learning neural network, or the like. The neural network may have one or more layers of nodes, and the model parameters adjusted during training may be respective weight values applied to one or more inputs to each node to produce a node output. In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer.

As model trainer module 818 cycles through the training data sets 814, model trainer module 818 applies a suitable backpropagation algorithm to adjust the weights in each node layer to minimize the error between the at least one output and the corresponding result data field. In this fashion, the machine learning model is trained to produce output that reliably predicts the corresponding result data field. Alternatively, the machine learning model may have any suitable structure.

In some embodiments, model trainer module 818 may provide an advantage by automatically discovering and properly weighting complex, second-or third-order, and/or otherwise nonlinear interconnections between the model input data fields and the at least one output. Absent the machine learning model, such connections are unexpected and/or undiscoverable by human analysts.

To facilitate this learning, the computing device may include one or more databases 802 at which the data is stored. This data becomes one or more input training sets used by the training set builder module 808. In exemplary embodiments, operational predictive model 806 may compare feedback, and may route a comparison result 822 generated by comparing data analysis 820 to the feedback to a model updater module 824 of the computing device. Model updater module 824 is configured to derive a correction signal 826 from comparison results 822 received for one or more analyses, and to provide correction signal 826 to model trainer module 818 to enable updating or “re-training” of the at least one machine learning model to improve performance. The retrained at least one machine learning model 816 may be periodically re-uploaded to operational predictive model 806.

### Exemplary Computer-Implemented Method for Generating Calendars Events Using Machine Learning Tools

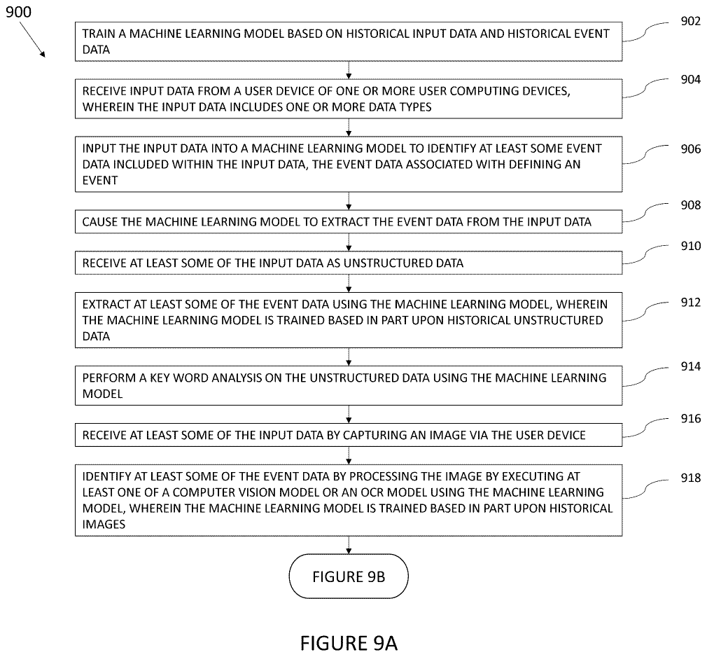

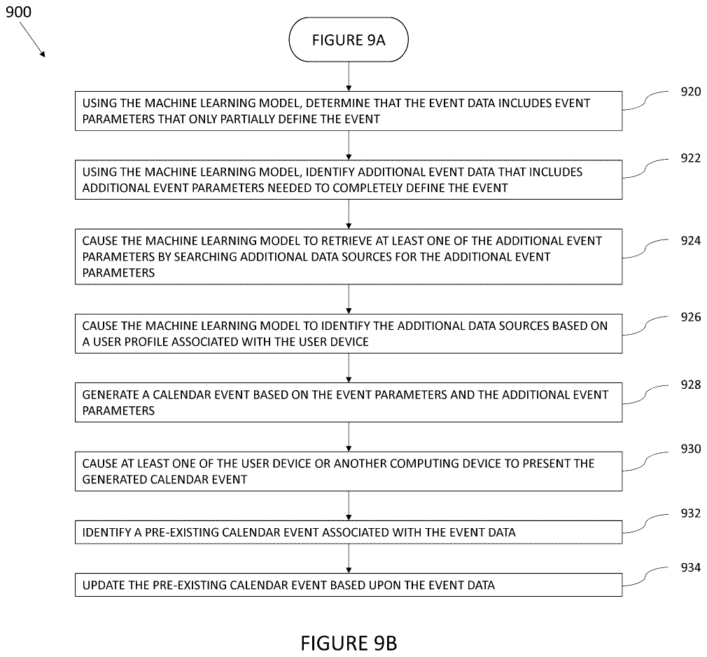

FIGS. 9A and 9B depict a flow chart of an exemplary computer-implemented method 900 for generating calendar events using machine learning tools and input data that may include one or more data types received over one or more channels of communication. Computer-implemented method 900 may be performed by event generation system 200 (shown in FIGS. 2 and 3).

Computer-implemented method 900 may include training (block 902) a machine learning model based upon historical input data and historical event data. In some exemplary implementations, the functions illustrated in block 902 may be performed by event generation server 202 (shown in FIGS. 2 and 3), for example, by executing machine learning module 305.

Computer-implemented method 900 may further include receiving (block 904) input data from a user device of one or more user computing devices, wherein the input data includes one or more data types. In some exemplary implementations, the functions illustrated in block 904 may be performed by event generation server 202 (shown in FIGS. 2 and 3), for example, by executing event identification module 304.

Computer-implemented method 900 may further include inputting (block 906) the input data into the machine learning model to identify at least some event data included within the input data, the event data associated with defining an event. In some exemplary implementations, the functions illustrated in block 906 may be performed by event generation server 202 (shown in FIGS. 2 and 3), for example, by executing machine learning module 305.

Computer-implemented method 900 may further include causing (block 908) the machine learning model to extract the event data from the input data. In some exemplary implementations, the functions illustrated in block 908 may be performed by event generation server 202 (shown in FIGS. 2 and 3), for example, by executing machine learning module 305.

In certain embodiments, computer-implemented method 900 may further include receiving (block 910) at least some of the input data as unstructured data, extracting (block 912) at least some of the event data using the machine learning model, wherein the machine learning model is trained based in part upon historical unstructured data, and performing (block 914) a key word analysis on the unstructured data using the machine learning model. In some exemplary implementations, the functions illustrated in block 910, block 912, and/or block 914 may be performed by event generation server 202 (shown in FIGS. 2 and 3), for example, by executing machine learning module 305.

In some embodiments, computer-implemented method 900 may further include receiving (block 916) at least some of the input data by capturing an image via the user device and identifying (block 918) at least some of the event data by processing the image by executing at least one of a computer vision model or an optical character recognition (OCR) model using the machine learning model, wherein the machine learning model is trained based in part upon historical images. In some exemplary implementations, the functions illustrated in block 916 and/or block 918 may be performed by event generation server 202 (shown in FIGS. 2 and 3), for example, by executing machine learning module 305 and/or computer vision module 325.

Computer-implemented method 900 may further include, using the machine learning model, determining (block 920) that the event data includes event parameters that only partially define the event. In some exemplary implementations, the functions illustrated in block 920 may be performed by event generation server 202 (shown in FIGS. 2 and 3), for example, by executing machine learning module 305.

Computer-implemented method 900 may further include, using the machine learning model, identifying (block 922) additional event data that includes additional event parameters needed to completely define the event. In some exemplary implementations, the functions illustrated in block 922 may be performed by event generation server 202 (shown in FIGS. 2 and 3), for example, by executing machine learning module 305.

Computer-implemented method 900 may further include causing (block 924) the machine learning model to retrieve at least one of the additional event parameters by searching additional data sources for the additional event parameters. In certain embodiments, computer-implemented method 900 may further include causing (block 926) the machine learning model to identify the additional data sources based upon a user profile associated with the user device. In some exemplary implementations, the functions illustrated in block 924 and/or block 926 may be performed by event generation server 202 (shown in FIGS. 2 and 3), for example, by executing machine learning module 305 and/or analysis module 306.

Computer-implemented method 900 may further include generating (block 928) a calendar event based upon the event parameters and the additional event parameters. In some embodiments, computer-implemented method 900 may further include causing (block 930) at least one of the user device or another computing device to present the generated calendar event. In some exemplary implementations, the functions illustrated in block 928 and/or block 930 may be performed by event generation server 202 (shown in FIGS. 2 and 3), for example, by executing event generation module 308.

In certain embodiments, computer-implemented method 900 may further include identifying (block 932) a pre-existing calendar event associated with the event data and updating (block 934) the pre-existing calendar event based upon the event data. In some exemplary implementations, the functions illustrated in block 932 and/or block 924 may be performed by event generation server 202 (shown in FIGS. 2 and 3), for example, by executing event generation module 308.

### Exemplary Embodiments & Functionality

In one aspect, a computer system for generating calendar events using machine learning tools and input data that includes one or more data types received over one or more channels of communication may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, machine learning models, ChatGPT or ChatGPT-based bots, and/or other electronic or electrical components, which may be in wired or wireless communication with one another. For example, in one instance, the computer system may include at least one processor and/or associated transceiver in communication with at least one memory device and in further communication with one or more user computing devices. The at least one processor may be programmed to: (1) receive input data from a user device of the one or more user computing devices, wherein the input data includes one or more data types; (2) input the input data into a machine learning model to identify at least some event data included within the input data, the event data associated with defining an event; (3) cause the machine learning model to extract the event data from the input data; (4) using the machine learning model, determine that the event data includes event parameters that only partially define the event; (5) using the machine learning model, identify additional event data that includes additional event parameters needed to completely define the event; (6) cause the machine learning model to retrieve at least one of the additional event parameters by searching additional data sources for the additional event parameters; and/or (7) generate a calendar event based upon the event parameters and the additional event parameters. The computer system may have additional, less, or alternate functionality, including that discussed elsewhere herein.

In another aspect, a computer-implemented method for generating calendar events using machine learning tools and input data that includes one or more data types received over one or more channels of communication may be provided. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality (XR) glasses or headsets, voice bots or chatbots, machine learning models, ChatGPT or ChatGPT-based bots, and/or other electronic or electrical components, which may be in wired or wireless communication with one another and function as input and/or output devices. For example, in one instance, the computer-implemented method may be implemented by a computer system including at least one processor and/or associated transceiver in communication with at least one memory device and in further communication with one or more user computing devices. The method may include: (1) receiving, by the at least one processor, input data from a user device of the one or more user computing devices, wherein the input data includes one or more data types; (2) inputting, by the at least one processor, the input data into a machine learning model to identify at least some event data included within the input data, the event data associated with defining an event; (3) causing, by the at least one processor, the machine learning model to extract the event data from the input data; (4) using the machine learning model, determining, by the at least one processor, that the event data includes event parameters that only partially define the event; (5) using the machine learning model, identifying, by the at least one processor, additional event data that includes additional event parameters needed to completely define the event; (6) causing, by the at least one processor, the machine learning model to retrieve at least one of the additional event parameters by searching additional data sources for the additional event parameters; and/or (7) generating, by the at least one processor, a calendar event based upon the event parameters and the additional event parameters. The computer-implemented method may include additional, less, or alternate actions, including those discussed elsewhere herein.

In another aspect, at least one non-transitory computer-readable media having computer-executable instructions embodied thereon for generating calendar events using machine learning tools and input data that includes one or more data types received over one or more channels of communication may be provided. The computer-executable instructions may be executed via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality (XR) glasses or headsets, voice bots or chatbots, machine learning models, ChatGPT or ChatGPT-based bots, and/or other electronic or electrical components, which may be in wired or wireless communication with one another and function as input and/or output devices. For example, in one instance, the computer-executable instructions may be executed by a computer system including at least one local or remote processor and/or associated transceivers in communication with at least one local or remote memory device and in further communication with one or more user computing devices. The computer-executable instructions may direct or cause the at least one processor to: (1) receive input data from a user device of the one or more user computing devices, wherein the input data includes one or more data types; (2) input the input data into a machine learning model to identify at least some event data included within the input data, the event data associated with defining an event; (3) cause the machine learning model to extract the event data from the input data; (4) using the machine learning model, determine that the event data includes event parameters that only partially define the event; (5) using the machine learning model, identify additional event data that includes additional event parameters needed to completely define the event; (6) cause the machine learning model to retrieve at least one of the additional event parameters by searching additional data sources for the additional event parameters; and/or (7) generate a calendar event based upon the event parameters and the additional event parameters. The non-transitory computer-readable media may direct additional, less, or alternate functionality, including that discussed elsewhere herein.

In another aspect, a computer system generating calendar events may be provided. The computer system may include one or more local or remote processors, servers, transceivers, sensors, memory units, mobile devices, wearables, smart watches, smart contact lenses, smart glasses, augmented reality glasses, virtual reality headsets, mixed or extended reality glasses or headsets, voice bots, chatbots, machine learning models, ChatGPT or ChatGPT-based bots, and/or other electronic or electrical components, which may be in wired or wireless communication with one another, and operate as input and/or output devices. For example, in one instance, the computer system may include at least one processor and/or associated transceiver in communication with at least one memory device and in communication with a user device associated with a user. The at least one processor may be programmed to: (1) receive user input data from a user device of the one or more user computer devices; (2) execute a machine learning model to identify an event from the user input data including extracting event data from the user input data; (3) detect, using the machine learning model, incomplete event data from the user input data; (4) generate additional event data with the machine learning model, wherein the additional event data is based upon a user profile; (5) generate a calendar event based upon the event data and the additional event data; (6) generate a prompt corresponding to the calendar event; (7) present, on the user device, the prompt corresponding to the calendar event, (8) receive the additional user data from the user computer device; (9) generate, with the machine learning model, an updated event based upon the additional user data; (10) upload the event data of the updated event to a database including a dashboard application; (11) store the updated event on the database, the database in communication with a plurality of users; and/or (12) display the calendar event on the dashboard application for each user associated with the updated event, wherein the dashboard is configured to execute on the user computer device. The computer system may have additional, less, or alternate functionality, including that discussed elsewhere herein.

In another aspect, a computer-implemented method for generating a virtual reality replicant persona for interaction with at least one user may be provided. The computer-implemented method may be implemented via one or more local or remote processors, servers, transceivers, sensors, memory units, mobile devices, wearables, smart watches, smart contact lenses, smart glasses, augmented reality (AR) glasses, virtual reality (VR) headsets, mixed reality (MR) or extended reality (XR) glasses or headsets, voice bots or chatbots, machine learning models, ChatGPT or ChatGPT-based bots, and/or other electronic or electrical components, which may be in wired or wireless communication with one another, and operate as input and/or output devices. For example, in one instance, the computer-implemented method may be implemented by a computer system including at least one processor and/or associated transceiver in communication with at least one memory device and in communication with a user device associated with a user. The method may include: (1) receiving user input data from a user device of the one or more user computer devices; (2) executing a machine learning model to identify an event from the user input data including extracting event data from the user input data; (3) detecting, using the machine learning model, incomplete event data from the user input data; (4) generating additional event data with the machine learning model, wherein the additional event data is based upon a user profile; (5) generating a calendar event based upon the event data and the additional event data; (6) generating a prompt corresponding to the calendar event; (7) presenting, on the user device, the prompt corresponding to the calendar event, (8) receiving the additional user data from the user computer device; (9) generating, with the machine learning model, an updated event based upon the additional user data; (10) uploading the event data of the updated event to a database including a dashboard application; (11) storing the updated event on the database, the database in communication with a plurality of users; and/or (12) displaying the calendar event on the dashboard application for each user associated with the updated event, wherein the dashboard is configured to execute on the user computer device. The computer-executable instructions may direct additional, less, or alternate functionality, including that discussed elsewhere herein.

### Machine Learning & Other Matters

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally, or alternatively, the machine learning programs may be trained by inputting sample data sets or certain data into the programs, such as image, mobile device, vehicle telematics, and/or intelligent home telematics data. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing - either individually or in combination. The machine learning programs may also include natural language processing, semantic analysis, automatic reasoning, and/or machine learning.

In supervised machine learning, a processing element may be provided with example inputs and their associated outputs and may seek to discover a general rule that maps inputs to outputs, so that when subsequent novel inputs may be provided the processing element may, based upon the discovered rule, accurately predict the correct output. In unsupervised machine learning, the processing element may be required to find its own structure in unlabeled example inputs. In one embodiment, machine learning techniques may be used to extract the relevant user data and/or event data and/or additional data for users from mobile device sensors, vehicle-mounted sensors, home-mounted sensors, server devices and/or other sensor data, vehicle or home telematics data, image data, and/or other data.

In one embodiment, a processing element may be trained by providing it with a large sample of conventional analog and/or digital, still and/or moving (e.g., video) image data, telematics data, and/or other data of events, users and/or additional data with known characteristics or features. Such information may include, for example, information needed to schedule events within a virtual calendar.

Based upon these analyses, the processing element may learn how to identify characteristics and patterns that may then be applied to analyzing sensor data, user data, event data, image data, mobile device data, and/or other data. For example, the processing element may learn, with the user's permission or affirmative consent, to identify events that are scheduled and/or patterns of events for users, such as by analysis of emails, texts, digital invites, pictures, digital images, etc. As a result, at the time of an event is communicated to a user, the system is able to translate that event into a complete calendar entry that is then entered into the virtual calendar.

In some embodiments, voice bots or chatbots, such as those discussed herein, may be configured to utilize AI (artificial intelligence) and/or ML (machine learning) techniques. For instance, the chatbot may be a large language model such as OpenAI GPT-4, Meta LLaMa, or Google PaML 2. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT.

### Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and may be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples may be example only and may be thus not intended to limit in any way the definition and/or meaning of the term “processor.”

As used herein, the term “database” may refer to either a body of data, a relational database management system (RDBMS), or to both. As used herein, a database may include any collection of data including hierarchical databases, relational databases, flat file databases, object-relational databases, object-oriented databases, and any other structured or unstructured collection of records or data that is stored in a computer system. The above examples may be not intended to limit in any way the definition and/or meaning of the term database. Examples of RDBMS's include, but may be not limited to, Oracle® Database, MySQL, IBM® DB2, Microsoft® SQL Server, Sybase®, and PostgreSQL. However, any database may be used that may enable the systems and methods described herein. (Oracle is a registered trademark of Oracle Corporation, Redwood Shores, California; IBM is a registered trademark of International Business Machines Corporation, Armonk, New York; Microsoft is a registered trademark of Microsoft Corporation, Redmond, Washington; and Sybase is a registered trademark of Sybase, Dublin, California.).

As used herein, the terms “software” and “firmware” may be interchangeable and include any computer program stored in memory for execution by a processor, including RAM memory, ROM memory, EPROM memory, EEPROM memory, and non-volatile RAM (NVRAM) memory. The above memory types may be example only and may be thus not limiting as to the types of memory usable for storage of a computer program.

In another embodiment, a computer program is provided, and the program is embodied on a computer-readable medium. In one exemplary embodiment, the system is executed on a single computer system, without requiring a connection to a server computer. In a further exemplary embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). In a further embodiment, the system is run on an iOS® environment (iOS is a registered trademark of Cisco Systems, Inc. located in San Jose, CA). In yet a further embodiment, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some embodiments, the system includes multiple components distributed among a plurality of computer devices. One or more components may be in the form of computer-executable instructions embodied in a computer-readable medium. The systems and processes may be not limited to the specific embodiments described herein. In addition, components of each system and each process may be practiced independent and separate from other components and processes described herein. Each component and process may also be used in combination with other assembly packages and processes. The present embodiments may enhance the functionality and functioning of computers and/or computer systems.

As used herein, an element or action or operation recited in the singular and preceded by the word “a” or “an” should be understood as not excluding plural elements or action or operations, unless such exclusion is explicitly recited. Furthermore, references to “exemplary embodiment” or “one embodiment” of the present disclosure may be not intended to be interpreted as excluding the existence of additional embodiments that also incorporate the recited features.

The patent claims at the end of this document may be not intended to be construed under 35 U.S.C. § 112(f) unless traditional means-plus-function language is expressly recited, such as “means for” or “action or operation for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples may be intended to be within the scope of the claims if they have structural elements that do not differ from the literal language of the claims, or if they include equivalent structural elements with insubstantial differences from the literal language of the claims.

We claim:

1. A computer system for generating calendar events using machine learning tools and input data that includes one or more data types received over one or more channels of communication, the computer system comprising at least one processor in communication with at least one memory and in further communication with one or more user computing devices, the at least one processor programmed to:
receive input data from a user device of the one or more user computing devices, wherein the input data includes one or more data types;
input the input data into a machine learning model to identify at least some event data included within the input data, the event data associated with defining an event;
cause the machine learning model to extract the event data from the input data;
using the machine learning model, determine that the event data includes event parameters that only partially define the event;
using the machine learning model, identify additional event data that includes additional event parameters needed to further define the event;
cause the machine learning model to retrieve at least one of the additional event parameters by searching additional data sources for the additional event parameters; and
generate a calendar event based upon the event parameters and the additional event parameters.

2. The computer system of claim 1, wherein the at least one processor is further programmed to cause the machine learning model to identify the additional data sources based upon a user profile associated with the user device.

3. The computer system of claim 2, wherein the user profile includes historical input data and historical event data, and wherein the at least one processor is further programmed to train the machine learning model based upon the historical input data and the historical event data.

4. The computer system of claim 1, wherein the at least one processor is further programmed to:
receive at least some of the input data as unstructured data; and
extract at least some of the event data using the machine learning model, wherein the machine learning model is trained based in part upon historical unstructured data.

5. The computer system of claim 4, wherein the at least one processor is further programmed to perform a key word analysis on the unstructured data using the machine learning model.

6. The computer system of claim 1, wherein the at least one processor is programmed to:
receive at least some of the input data by capturing an image via the user device; and
identify at least some of the event data by processing the image by executing at least one of a computer vision model or an optical character recognition (OCR) model using the machine learning model, wherein the machine learning model is trained based in part upon historical images.

7. The computer system of claim 1, wherein the at least one processor is further programmed to receive at least some of the input data as one or more of audio data, image data, video data, text data, email data, text message data, social media interaction data, screen data, sensor data, structured data, unstructured data, or data generated by a mobile application.

8. The computer system of claim 1, wherein the processor is further programmed to:
identify a pre-existing calendar event associated with the event data; and
update the pre-existing calendar event based upon the event data.

9. The computer system of claim 1, wherein the event parameters include one or more of a location, a date, a time, a duration, invited users, invitation acceptance status, an event type, an event description, scheduling conflicts, or navigation information.

10. The computer system of claim 1, wherein the at least one processor is further programmed to present a prompt via the user device requesting input of at least one of the additional event parameters.

11. The computer system of claim 1, wherein the at least one processor is further programmed to cause at least one of the user device or another computing device to present the generated calendar event.

12. The computer system of claim 11, wherein the generated calendar event is presented via a dashboard application executed by the user device.

13. A computer-implemented method for generating calendar events using machine learning tools and input data that includes one or more data types received over one or more channels of communication, the computer-implemented method performed by at least one processor in communication with at least one memory and in further communication with one or more user computing devices, the computer-implemented method comprising:
receiving, by the at least one processor, input data from a user device of the one or more user computing devices, wherein the input data includes one or more data types;
inputting, by the at least one processor, the input data into a machine learning model to identify at least some event data included within the input data, the event data associated with defining an event;
causing, by the at least one processor, the machine learning model to extract the event data from the input data;
using the machine learning model, determining, by the at least one processor, that the event data includes event parameters that only partially define the event;
using the machine learning model, identifying, by the at least one processor, additional event data that includes additional event parameters needed to further define the event;
causing, by the at least one processor, the machine learning model to retrieve at least one of the additional event parameters by searching additional data sources for the additional event parameters; and
generating, by the at least one processor, a calendar event based upon the event parameters and the additional event parameters.

14. The computer-implemented method of claim 13, further comprising causing, by the at least one processor, the machine learning model to identify the additional data sources based upon a user profile associated with the user device.

15. The computer-implemented method of claim 14, wherein the user profile includes historical input data and historical event data, and wherein the computer-implemented method further comprises training, by the at least one processor, the machine learning model based upon the historical input data and the historical event data.

16. The computer-implemented method of claim 13, further comprising:
receiving, by the at least one processor, at least some of the input data as unstructured data; and
extracting, by the at least one processor, at least some of the event data using the machine learning model, wherein the machine learning model is trained based in part upon historical unstructured data.

17. The computer-implemented method of claim 16, further comprising performing, by the at least one processor, a key word analysis on the unstructured data using the machine learning model.

18. The computer-implemented method of claim 13, further comprising:
receiving, by the at least one processor, at least some of the input data by capturing an image via the user device; and
identifying, by the at least one processor, at least some of the event data by processing the image by executing at least one of a computer vision model or an optical character recognition (OCR) model using the machine learning model, wherein the machine learning model is trained based in part upon historical images.

19. The computer-implemented method of claim 13, further comprising receiving, by the at least one processor, at least some of the input data as one or more of audio data, image data, video data, text data, email data, text message data, social media interaction data, screen data, sensor data, structured data, unstructured data, or data generated by a mobile application.

20. At least one non-transitory computer-readable storage media having computer-executable instructions embodied thereon for generating calendar events using machine learning tools and input data that includes one or more data types received over one or more channels of communication, wherein when executed by at least one processor in communication with at least one memory and in further communication with one or more user computing devices, the computer-executable instructions cause the at least one processor to:
receive input data from a user device of the one or more user computing devices, wherein the input data includes one or more data types;
input the input data into a machine learning model to identify at least some event data included within the input data, the event data associated with defining an event;
cause the machine learning model to extract the event data from the input data;
using the machine learning model, determine that the event data includes event parameters that only partially define the event;
using the machine learning model, identify additional event data that includes additional event parameters needed to further define the event;
cause the machine learning model to retrieve at least one of the additional event parameters by searching additional data sources for the additional event parameters; and
generate a calendar event based upon the event parameters and the additional event parameters.
